(19) United States
(12) Patent Application Publication
(10) Pub. No.: US 2011/0052897 A1
(43) Pub. Date: Mar. 3, 2011

(54) THERMAL INSULATION MATERIAL

(75) Inventors: Yoshihiko Goto, Tokyo (JP); Yasuo Ito, Tokyo (JP); Ken Maeda, Tokyo (JP); Akifumi Sakamoto, Tokyo (JP)

(73) Assignee: NICHIAS CORPORATION, Tokyo (JP)

(21) Appl. No.: 12/874,393

(22) Filed: Sep. 2, 2010

(30) Foreign Application Priority Data
Sep. 2, 2009 (JP) 2009-202742
Aug. 24, 2010 (JP) 2010-187403

(51) Int. Cl. B32B 7/08

(52) U.S. Cl. 428/223; 156/92

(57) ABSTRACT

The present invention relates to a thermal insulation material including a first molded article formed by compression-molding inorganic nanoparticles, a second molded article laminated on at least one side of the first molded article and having a bending strength of at least 0.4 MPa, and an accouplement coupling the first molded article and the second molded article.

### TECHNICAL FIELD

The present invention relates to a thermal insulation material having low thermal conductivity and containing inorganic nanoparticles of fumed silica or the like.

### BACKGROUND ART

A thermal insulation material is used in building materials, industrial furnaces, incinerators, etc., and a thermal insulation material containing fumed silica has become used since it is more excellent in thermal insulation capability and is capable of attaining body-weight reduction and thickness reduction. Fumed silica is a silica ultrafine powder produced according to a vapor phase method and having an average particle size of at most 50 nm, which is a low-conductive material having a thermal conductivity of about 0.01 W/m·K at room temperature (25° C.). Associating with each other through intermolecular force or the like, fumed silica forms secondary particles having a diameter of tens nm to a few μm, in which a large number of spaces having a ring inner diameter of at most 0.1 μm are formed. Since such spaces axe smaller than the mean free path of air to be a heat-transfer medium, it is possible to significantly reduce heat transfer via fumed silica.

A thermal insulation material containing such fumed silica is produced, generally not adding a binder thereto. This is because, a binder, if added, may serve as a heat-transfer path by itself, therefore increasing the thermal conductivity of the material. As a result, the strength of the material is extremely small as compared with that of ordinary thermal insulation materials, and the handlability, the processability and the workability thereof may be poor. Accordingly, the present applicant has previously proposed a thermal insulator that includes a thermal insulation material produced by adhering fumed silica to inorganic fibers not using a binder (see Patent Document 1).

### BACKGROUND ART DOCUMENT

### Patent Reference

Patent Document 1: JP-A 2004-353128

### SUMMARY OF THE INVENTION

### Problems that the Invention is to Solve

However, even in the thermal insulation material described in Patent Document 1, fumed silica may be released from the inorganic fibers to be a dust powder, and further improvement of the material in points of the handlability, the processability and the workability thereof is desired.

Accordingly, an object of the present invention is to provide a thermal insulation material capable of expressing high thermal insulation capability that fumed silica possesses and excellent in handlability, processability and workability.

### Means for Solving the Problems

To attain the above object, the invention provides a laminate thermal insulation material mentioned below.

(1) A thermal insulation material including a first molded article formed by compression-molding inorganic nanoparticles, a second molded article laminated on at least one side of the first molded article and having a bending strength of at least 0.4 MPa, and an accouplement coupling the first molded article and the second molded article.
(2) The thermal insulation material according to (1), in which the accouplement is a rod-like or wire-like one.
(3) The thermal insulation material according to (1) or (2), in which the accouplement contains carbon or glass.
(4) The thermal insulation material according to any one of (1) to (3), in which the accouplement is embedded vertically or obliquely relative to an interface between the first molded article and the second molded article.
(5) A method for producing a thermal insulation material, the method including:

laminating a second molded article having a bending strength of at least 0.4 MPa on at least one side of a first molded article formed by compression-molding inorganic nanoparticles, and

inserting a rod-like or wire-like accouplement to couple the first molded article and the second molded article.

(6) The method for producing a thermal insulation material according to (5), in which the accouplement is inserted vertically or obliquely relative to an interface between the first molded article and the second molded article.

### ADVANTAGE OF THE INVENTION

Additionally including the second molded article as coupled therein, the thermal insulation material of the invention has enhanced handlability, processability and workability while securing the excellent thermal insulation capability due to the first molded article of inorganic nanoparticles such as fumed silica.

The production method is extremely simple, in which the first molded article and the second molded article are laminated and a rod-like or wire-like accouplement such as a pin is inserted therein.

### BRIEF DESCRIPTION OF THE DRAWINGS

FIG. 1A and FIG. 1B each are a cross-sectional view showing one example (two-layered structure) of the thermal insulation material of the invention.

FIG. 2A and FIG. 2B each are a view showing the insertion angle of an accouplement.

FIG. 3 is a view showing a modification example of the insertion part of an accouplement.

FIG. 4 is a cross-sectional view showing an example of coating the first molded article with a coating material.

FIG. 5A and FIG. 5B each are a cross-sectional view showing another example (three-layered structure) of the thermal insulation material of the invention.

FIG. 6A and FIG. 6B each are a view showing a modification example of the insertion part of the accouplement in the three-layered thermal insulation material shown in FIG. 5.

FIG. 7 is a view showing a modification example of the insertion part of the accouplement in the three-layered thermal insulation material shown in FIG. 5.

FIG. 8A and FIG. 8B each are a view showing a modification example of the insertion part of the accouplement in the three-layered thermal insulation material shown in FIG. 5.

FIGS. 9A to 9C each are a view showing a modification example of the insertion part of the accouplement in the three-layered thermal insulation material shown in FIG. 5.

### MODE FOR CARRYING OUT THE INVENTION

The invention is described in detail with reference to the drawings. The invention is not limited to the embodiments illustrated herein.

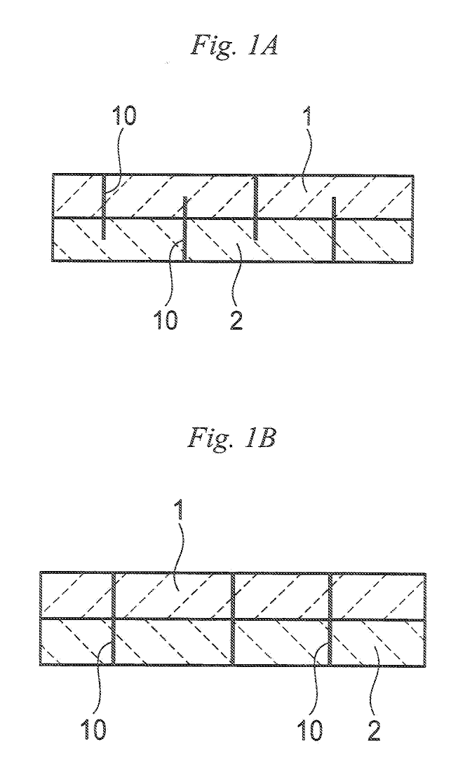

The laminate thermal insulation material of the invention includes a first molded article 1 formed by compression-molding inorganic nanoparticles, a second molded article 2 being laminated thereon and having a bending strength of at least 0.4 MPa, in which the articles are coupled together via a rod-like or wire-like accouplement 10, as shown in the cross-sectional views of FIG. 1A and FIG. 1B. In the invention, the bending strength may be measured, for example, according to JIS A 9510. FIG. 1A and FIG. 1B differ from each other in the coupling method with the accouplement 10. FIG. 1A shows an example where accouplements 10 shorter than the height (overall thickness) of the laminate of the first molded article 1 and the second molded article 2 are inserted alternately into the surface and the back thereof at predetermined intervals; and FIG. 1B shows an example where accouplements 10 of which the thickness is the same or slightly shorter than the overall thickness are inserted at predetermined intervals.

In this, in laminating the first molded article 1 formed by compression-molding inorganic nanoparticles and the second molded article 2 having a bending strength of at least 0.4 MPa, for example, a technique of fixing them with a known adhesive may be taken into consideration. However, owing to the liquid having a large polarity such as water, the inorganic nanoparticles of, for example, fumed silica in the first molded article 1 would rapidly cohere, and therefore the surface of the first molded article 1 may have deformations of cracks or caves.

The first molded article 1 does not contain a binder but is exclusively compression-molded, and therefore, its strength is extremely poor and its surface is dusty; and accordingly, even though the article could be fixed with an adhesive, it may readily peel away at the interface between the part into which the adhesive penetrated and the part into which the adhesive did not penetrate, and the article may readily peel away by a slight force.

As the accouplement 10, usable is a rod-like or wire-like body formed of metal such as iron, stainless or aluminium, or ceramic, carbon, resin, fiber-reinforced plastic (hereinafter this may be referred to as FRP) or glass; and this may be a molded one or a thick wire-like one produced by twining thin wire-like ones. Above all, preferred are those having high strength and elasticity but having low thermal conductivity so as not to transmit heat through themselves; and more preferred are carbon-made or glass-made ones, or those containing carbon or glass. The carbon or glass-containing accouplements may be, for example, FRP rods such as carbon-FRP rods or glass-FRP rods produced by fixing carbon fibers or glass fibers with a resin binder.

The accouplement 10 may be provided with, for example, an axial part with a continuous cross section having a desired shape. The cross-section profile of the axial part is not specifically defined, including, for example, circular, oval, rectangular and square forms. The thickness (largest diameter) of the axial part is not specifically defined, but must be in such a degree that the first molded article 1 and the second molded article 2 do not peel away from each other; and for example, the thickness may be from 0.2 to 4 mm, preferably from 0.5 to 2 mm, more preferably from 0.8 to 1.2 mm. The accouplement 10 may be so designed that its axial part has a sharp tip on one end thereof, like a nail, or may be so designed that its axial part has, on the other end thereof, a head having a larger section area than the section area of the axial part.

Not specifically defined, the bending strength of the accouplement 10 may be at least 10 MPa, preferably at least 20 MPa, more preferably at least 30 MPa, and it may be 100 MPa or more, or 500 MPa or more. Having the bending strength, the accouplement is usable with no trouble when inserted into the first molded article 1 and the second molded article 2.

The density of the accouplement 10, or that is, the number of the accouplements per unit area is not specifically defined so far as the first molded article 1 and the second molded article 2 could keep their laminate state; however, in case where excessive accouplements are provided, they would lower the thermal insulation capability of the thermal insulation material. Accordingly, the number is suitably from 4 to 120/m², preferably from 9 to 90/m², more preferably from 16 to 80/m², even more preferably from 25 to 75/m².

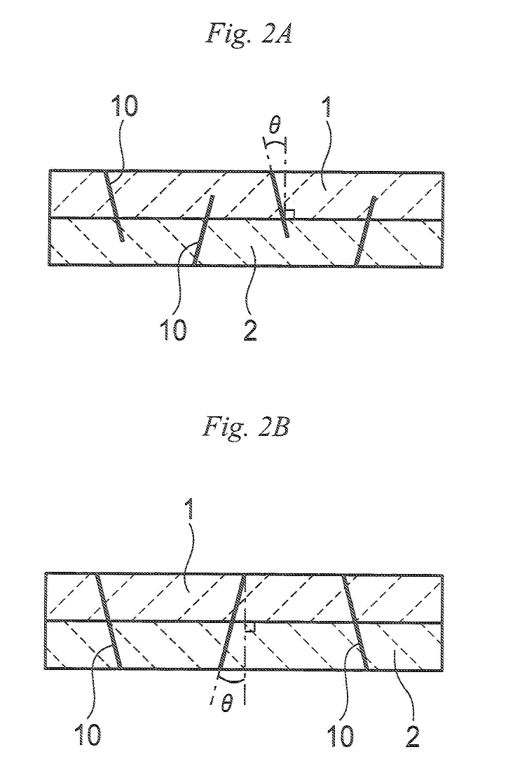

Regarding the insertion mode thereof, the accouplement 10 may be inserted vertically to the interface between the first molded article 1 and the second molded article 2 as shown in FIGS. 1A and 1B, or may be inserted obliquely thereto as shown in FIGS. 2A and 2B. Not specifically defined, the tilt angle θ may be, for example, from 0° to 50°, preferably from 1° to 45°, more preferably from 5° to 30°. The tilt angle may differ between the accouplements. Also not specifically defined, the distance between the accouplement 10 and the accouplement 10 may be, for example, from 10 to 40 mm.

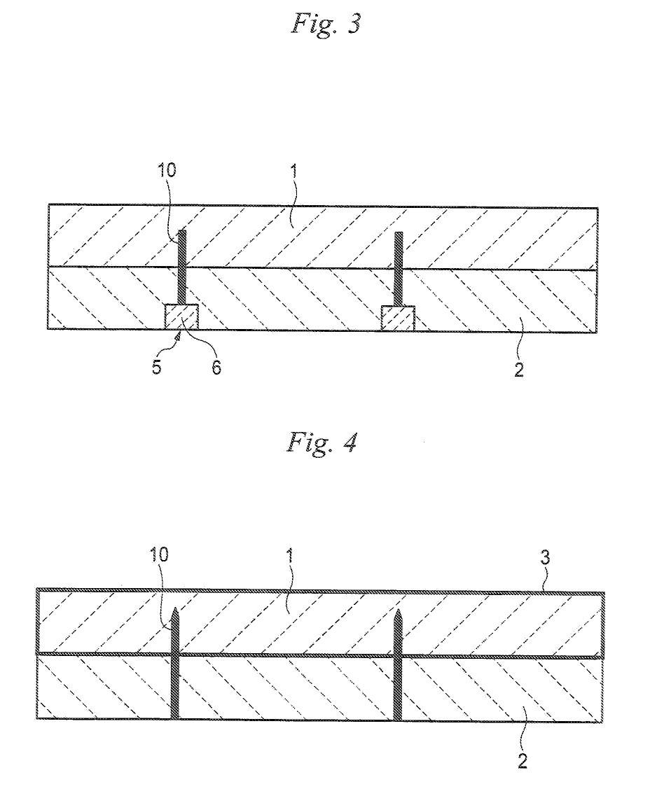

As shown in FIG. 3, a recess 5 may be formed in the surface of the second molded article 2 and an accouplement 10 is inserted into the recess 5, and thereafter the recess 5 may be filled with a filler 6. Accordingly, the rod-like or wire-like accouplement 10 does not protrude out, therefore securing safe working operation and construction operation.

As the inorganic nanoparticles, for example, usable are those of which the primary particles have an average particle diameter falling within a range of from 1 to 100 nm. The average particle diameter of the primary particles of the inorganic nanoparticles may be preferably within a range of from 1 to 50 nm, more preferably within a range of from 1 to 25 nm, even more preferably within a range of from 1 to 15 “a”, still more preferably within a range of from 1 to 10 nm. The average diameter is a reduced particle diameter D (m) computed according to a formula “D=6/(a×S)” where “a” means the true density (g/m³) of the inorganic nanoparticle, and “S” means the specific surface area (m²/g) of the inorganic nanoparticle. For example, the true density of silica is 2.2×10⁶ g/m³, and therefore, the average diameter (reduced particle diameter) of silica nanoparticles having a specific surface area of 300 m²/g is computed to be about 9 nm.

Primary particles having an average diameter of at most 100 nm may gather to form secondary particles. Accordingly, the first molded article formed by compression-molding inorganic nanoparticles is an aggregate of secondary particles of inorganic nanoparticles. Using nanoparticles of which the primary particles have a small average particle diameter reduces the size of the spaces to be formed inside the secondary particles. Further, reducing the size of the spaces effectively prevents the air convection inside the first molded article. Accordingly, the first molded article formed by compression-molding nanoparticles of which the primary particles have an average diameter of less than 10 nm can have excellent thermal insulation capability.

As the inorganic nanoparticles, those formed from a metal oxide such as silica, alumina, titanium oxide or the like can be preferably used. Above all, using nanoparticles of silica (silica nanoparticles) effectively enhances the thermal insulation capability of the first molded article. Accordingly, the first molded article formed by compression-molding silica nanoparticles can have especially excellent thermal insulation capability.

As the silica nanoparticles, preferred for use herein is dry silica (so-called fumed silica) produced according to a vapor-phase method, or wet silica produced according to a liquid-phase method. As the dry silica, for example, hydrophilic fumed silica having a lot of hydrophilic groups such as silanol groups on the surface thereof and a hydrophobic fumed silica produced by hydrophobicating the surface of the hydrophilic fumed silica may be preferably used. The first molded article formed by compression-molding hydrophobic fumed silica hardly undergoes thermal insulation reduction through moisture absorption, as compared with the molded article formed by compression-molding hydrophilic fumed silica.

The first molded article may further contain a fibrous material in addition to the inorganic nanoparticles. In case where the first molded article contains a fibrous material, the fibrous material may be, for example, dispersed to be irregularly aligned fibers inside the first molded article. As such fibers, fibers formed from an inorganic material (inorganic fibers) and fibers formed from an organic material (organic fibers) may be preferably used.

Examples of the inorganic fibers include glass fibers, silica-alumina fibers, alumina fibers, silica fibers, zirconia fibers and alkali silicate fibers. Examples of the organic fibers include aramide fibers, carbon fibers, polyester fibers. Plural types of those fibers may be combined for use herein.

The fibers to be contained in the first molded article may be chopped fibers that are produced by chopping long fibers (filaments) having a predetermined fiber diameter (fiber size) to have a predetermined length. Concretely, for example, chopped glass fibers are usable here. The chopped fibers may have, for example, an average fiber diameter falling within a range of from 3 to 15 μm and an average length falling within a range of from 1 to 20 mm, and preferred are those having an average fiber diameter falling within a range of from 6 to 12 μm and an average length falling within a range of from 3 to 9 mm.

Using the above-mentioned fibers effectively prevents the first molded article from being cracked to be broken. Accordingly, the first molded article that contains such fibers may have an increased strength not accompanied by thermal insulation reduction, and therefore may provide good handlability.

The ratio of the fibers to the inorganic nanoparticles to be contained in the first molded article may be suitably determined in accordance with the necessary properties of the molded article (for example, thermal insulation capability, heat resistance, low dust generation). Specifically, the first molded article may contain inorganic nanoparticles, for example, in an amount falling within a range of from 50 to 99% by mass along with fibers in an amount falling within a range of from 1 to 50% by mass, preferably containing inorganic nanoparticles in an amount falling within a range of from 70 to 99% by mass along with fibers in an amount falling within a range of from 1 to 30% by mass, more preferably inorganic nanoparticles in an amount falling within a range of from 80 to 99% by mass along with fibers in an amount falling within a range of from 1 to 20% by mass.

The thermal conductivity of fibers or their aggregates is larger than the thermal conductivity of inorganic nanoparticles or their aggregates; and therefore, when the ratio of the fibers to be contained in the first molded article increases, then the thermal insulation capability of the molded article may tend to lower. Accordingly, preferably, the first molded article includes inorganic nanoparticles as the main ingredient thereof and contains fibers as the additive (side ingredient) thereto, as so mentioned in the above. The fibers added to the first molded article may impart good handlability to the molded article with keeping the thermal insulation capability of the molded article as such, as so mentioned in the above.

The first molded article 1 containing fumed silica as inorganic nanoparticles along with inorganic fibers is available on the market, for example, as Nippon Microtherm's “Microtherm”.

The first molded article may contain an IR-reflective agent or an IR absorbent. The IR-reflective agent is not specifically defined so far as it has the property of reflecting IR rays, for which, for example, usable are IR-reflective materials such as silicon carbide, titanium oxide, zinc oxide, iron oxide, etc. Preferred for use herein are particles of the IR-reflective material (IR-reflective particles). The IR absorbent is not specifically defined so far as it has the property of absorbing IR rays, for which, for example, usable are black materials such as carbon, graphite and the like (IR-absorbing materials). Preferred for use herein are particles of the IR-absorbing material (IR-absorbing particles). The content of the ER-reflective agent or the IR absorbent may be, for example, within a range of from 5 to 40% by mass, more preferably within a range of from 10 to 30% by mass.

Combined use of inorganic nanoparticles and fibers lowers the thermal conductivity of the molded article at around 100° C. or lower; however at 100° C. or higher, addition of an IR-reflective agent or an IR absorbent lowers the thermal conductivity and enhances the thermal insulation capability of the molded article. In most cases, thermal insulation materials are used at 100° C. or higher, and therefore, in general, an IR-reflective agent or an IR absorbent is added thereto. However, when the amount of the IR-reflective agent or the IR absorbent added is too much, the strength of the molded article may lower and the handlability thereof may worsen. Accordingly, the content of the inorganic nanoparticles in the first molded article is preferably at least 50% by mass, more preferably at least 60% by mass. The balance of the content is at least one of fibers and an IR-reflective agent or an IR absorbent, which may be suitably selected in accordance with the intended thermal insulation capability. The preferred blend ratio in the case is from 50 to 75% by mass of inorganic nanoparticles, from 2 to 15% by mass of inorganic fibers, and from 10 to 35% by mass of an IR-reflective agent or an IR absorbent.

In any case of (1) inorganic nanoparticles alone, (2) inorganic nanoparticles and fibers, or (3) inorganic nanoparticles and fibers combined with at least any one of an IR-reflective agent or an IR absorbent, the first molded article 1 is formed exclusively by compression molding, not using a binder. Accordingly, the strength of the first molded article 1 is extremely low, but, for example, when the bending strength thereof is from 0.1 to 0.35 MPa, the article may be well handled.

The density after compression molding of the first molded article 1 is preferably from 100 to 600 kg/m³, more preferably from 150 to 400 kg/m³, even more preferably from 200 to 300 kg/m³. Preferably, the thermal conductivity of the article at 600° C. is at most 0.1 W/mK, more preferably at most 0.07 W/mK, even more preferably at most 0.05 W/mK. Also preferably, the thermal conductivity of the article at 800° C. is at most 0.1 W/mK, more preferably at most 0.07 W/mK, even more preferably at most 0.04 W/mK.

The first molded article 1 is constituted as above, but for more effectively preventing fumed silica as the inorganic nanoparticles from dusting off, the article may be coated with a coating material 3 such as a glass cloth, a ceramic cloth or the like, as shown in FIG. 4; and this mode is especially effective in single use of inorganic nanoparticles for the article. In the case where the article is coated with the coating material 3, the accouplement 10 preferably has a sharpened tip for facilitating its insertion.

On the other hand, the second molded article 2 is a member for enhancing the handlability, the processability and the workability of the thermal insulation material as a whole, and its material is not specifically defined so far as the article has a bending strength of at least 0.4 MPa, preferably at least 0.8 MPa, more preferably at least 1.0 MPa. For example, in case where heat resistance or thermal insulation capability is needed, a molded article that contains inorganic fibers, calcium silicate or the like may be used.

The second molded article 2 may be an inorganic fibrous molded article that includes inorganic fibers as the main ingredient thereof. For example, it may be an inorganic fibrous molded article containing from 50 to 95% by mass of inorganic fibers, from 5 to 30% by mass of a binder, from 0 to 30% by mass, preferably from 5 to 30 parts by mass of an inorganic powder. Not specifically defined, examples of the inorganic fibers include glass fibers, glass wool, rock wool, alumina fibers, zirconia fibers and silica/alumina fibers. One or more different types of such inorganic fibers may be used optionally as combined. Examples of the binder include an inorganic binder such as colloidal silica, alumina sol, zirconia sol, titania sol, and an organic binder such as acrylic resin, starch, polyacrylamide. One or more different types of such binders may be used optionally as combined.

If desired, an inorganic powder may be added to the inorganic fibrous molded article. Adding an inorganic powder increases the heat resistance of the article. Examples of the inorganic powder include ceramic powders such as silica, alumina, mullite, silicon nitride, silicon carbide, titania, zirconia or the like, and carbon powders such as carbon black or the like. Of those, preferred are ceramic powders such as silica, alumina, silicon nitride, silicon carbide, mullite, titania, zirconia or the like, and carbon powders such as carbon black or the like. More preferred are ceramic powders such as silica, alumina, silicon nitride, silicon carbide or the like. One or more different types of such inorganic powders may be used optionally as combined.

Not specifically defined, the density of the inorganic fibrous molded article may be from 100 to 700 kg/m³, preferably from 150 to 400 kg/m³, even more preferably from 200 to 300 kg/m³. The thermal conductivity at 600° C. of the article is preferably at most 0.3 W/mK, more preferably at most 0.2 W/mK, even more preferably at most 0.1 W/mK.

The inorganic fibrous molded article has excellent thermal insulation capability and may be used as a thermal insulation material by itself, and, for example, it is available on the market as Nichias's “Fineflex 1300 Hardboard”, “RF Board”, etc.

The second molded article may be a calcium silicate molded article that includes calcium silicate as the main ingredient thereof. In the invention, calcium silicate may be a compound produced through hydrothermal reaction between a siliceous starting material (SiO₂) and a calcium starting material (CaO) in the presence of water. Its crystal is not specifically defined, but examples thereof include xonotlite crystal, tobermorite crystal and amorphous C—S—H crystal. In particular, a molded article of xonotlite crystal is preferred as lightweight, having a relatively high specific strength and excellent in heat resistance and thermal insulation capability. The presence of those crystals can be confirmed through X-ray diffractiometry that gives diffraction peaks peculiar to the respective crystals. Accordingly, X-ray diffractiometry of the surface of the second molded article may readily confirm the presence or absence of the intended crystals.

In addition to calcium silicate therein, the calcium silicate molded article may optionally contain, as added thereto if desired, a reinforcing material such as cement, gypsum; a filler such as talc, diatomaceous earth, fly ash; reinforcing fibers such as glass fibers, ceramic fibers, alumina fibers, wollastonite, pulp, polypropylene fibers, aramide fibers, carbon fibers; light aggregates such as micro silica, pearlite, shirasu balloons, glass balloons, etc. In addition, the article may contain an unreacted siliceous material or calcareous material.

The calcium silicate molded article may contain, for example, the reinforcing material in an amount of from 0 to 20 parts by mass, preferably from 10 to 20 parts by mass, the filler in an amount of from 0 to 20 parts by mass, preferably from 0 to 10 parts by mass, the reinforcing fibers in an amount of from 0 to 20 parts by mass, preferably from 5 to 10 parts by mass, and the light aggregate in an amount of from 0 to 20 parts by mass, preferably from 5 to 10 parts by mass, relative to 100 parts by mass of calcium silicate therein.

Not specifically defined, the density of the calcium silicate molded article may be from 50 to 900 kg/m³, preferably from 80 to 600 kg/m³, more preferably from 100 to 400 kg/m³. The thermal conductivity at 600° C. of the article is preferably at most 0.2 W/mK, more preferably at most 0.18 W/mK, even more preferably at most 0.16 W/mK.

The calcium silicate molded article is preferred as lightweight, having high strength and excellent in, thermal insulation capability and beat resistance, and, for example, it is available on the market as Nichias's “Caslight H”, “Super Tempboard”, etc.

In case where the service temperature is within a relatively low temperature range of not higher than 50° C., a rigid foam resin molded article such as polyurethane foam, polyethylene foam, polypropylene foam or the like may be used for the second molded article 2. The rigid foam resin molded article is available on the market, for example, as Nichias's “Foamnart Board TN”, etc.

The thickness of the first molded article 1 and the second molded article 2, and the overall thickness of the thermal insulation material may be suitably selected in accordance with the intended thermal insulation capability. For example, the thickness of the first molded article 1 may be from 5 to 100 mm, preferably from 5 to 70 mm, more preferably from 10 to 40 mm, even more preferably from 20 to 30 mm. The thickness of the second molded article 2 may be from 5 to 100 mm, preferably from 5 to 70 mm, more preferably from 10 to 40 mm, even more preferably from 20 to 30 mm. The overall thickness of the thermal insulation material may be from 10 to 200 mm, preferably from 10 to 140 mm, more preferably from 40 to 90 mm, even more preferably from 60 to 80 mm. The first molded article 1 may be arranged to face a heat source, or the second molded article 2 may be arranged to face it; however, the heat resistance of the first molded article 1 is low, and therefore, for a heat source to give a high-temperature heat such as a furnace lining material, the second molded article 2 must be arranged to face the heat source.

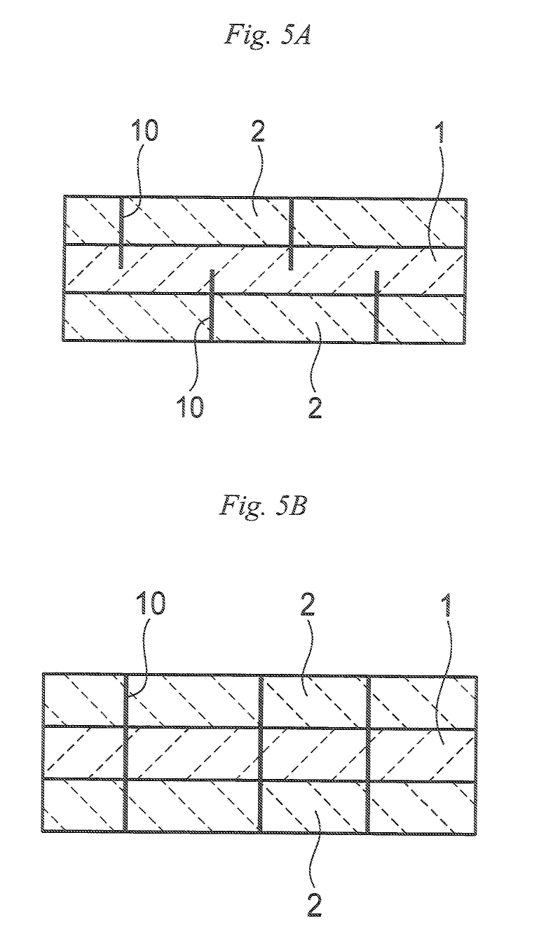

The invention includes various modifications, and, for example, as shown in FIGS. 5A and 5B, the thermal insulation material may have a three-layered structure in which the second molded article is laminated on both surfaces of the first molded article. In the three-layered embodiment, the first molded article 1 may be sandwiched between two second molded articles 2 and 2, as illustrated; and in this, the inorganic nanoparticles may be prevented from dusting off from the first molded article 1.

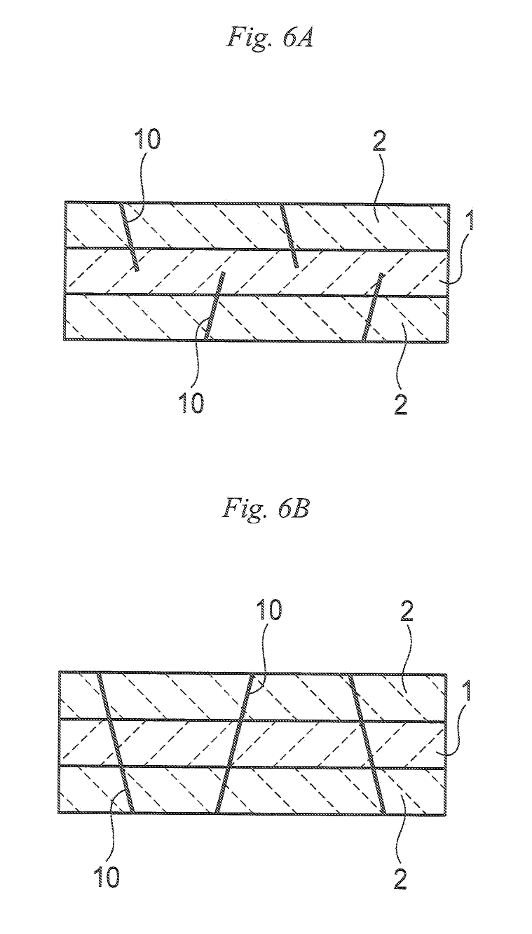

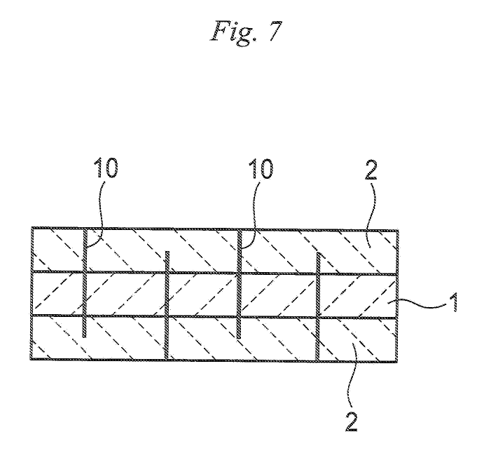

The accouplement 10 may be inserted in an oblique direction, as shown in FIGS. 6A and 6B. The tilt angle θ may be selected, as shown in FIG. 2. In the three-layered embodiment, the accouplement 10 may be inserted from one second molded article 2 to reach the other second molded article 2, as shown in FIG. 7. Not specifically defined, the distance between the accouplement 10 and the accouplement 10 may be, for example, from 10 to 40 mm.

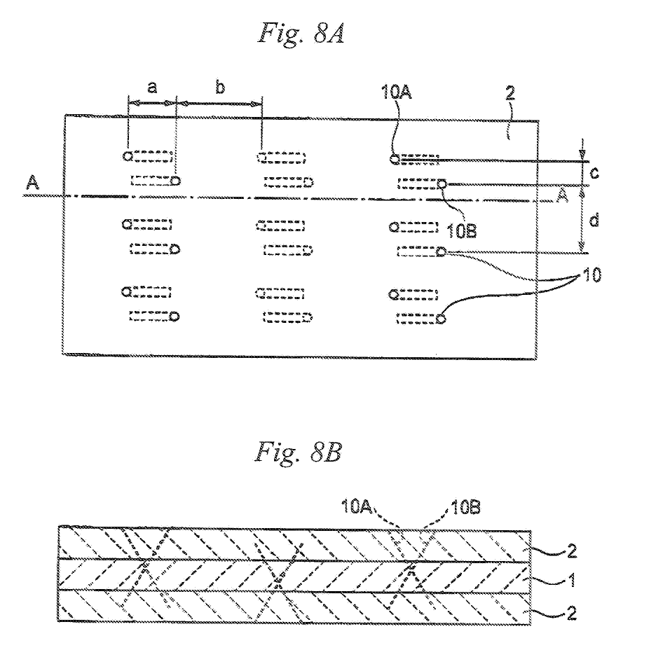

Further, as shown in FIG. 8 (FIG. 8A is a top view; FIG. 8B is an AA cross-sectional view), a pair of accouplements 10A and 10B may be crossed in contact or not in contact with each other in the thickness direction of the thermal insulation material (in the drawings, they are not in contact with each other) and inserted into the articles alignedly to thereby more effectively couple the articles of the three-layered structure. In this case, the distance a between the pair of accouplements 10A and 10B may be suitably from 3 to 50 mm, preferably from 5 to 10 mm; the distance b between the lines of the pair of accouplements 10A and 10B in the horizontal direction on the paper may be from 50 to 500 mm, preferably from 100 to 300 mm; the distance c between the pair of accouplements 10A and 10B may be from 0 to 30 mm, preferably from 3 to 10 mm; and the distance d between the lines of the pair of accouplements 10A and 10B in the vertical direction on the paper may be from 50 to 500 mm, preferably from 100 to 200 mm; however, these distances may be suitably selected depending on the area and the thickness of the thermal insulation material. The accouplements 10A and 10B may not be in parallel to each other as illustrated, but may be tilted from each other.

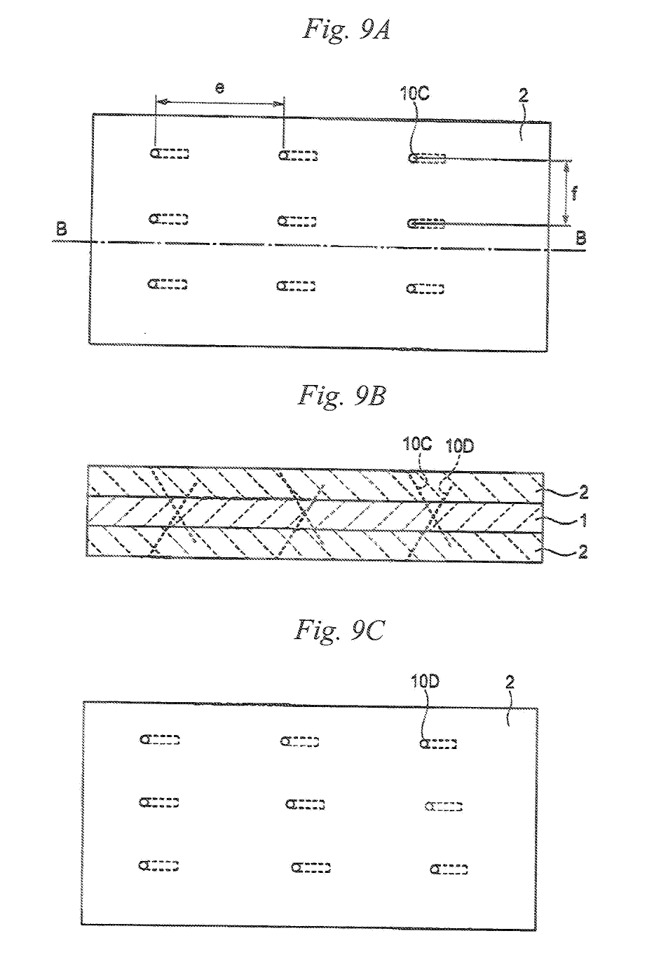

Further, as shown in FIG. 9 (FIG. 9A is a top view; FIG. 9B is a BB cross-sectional view; FIG. 9C is a bottom view), one of accouplements 10C and 10D (in this, 10C) may be inserted from the top while the other (in this, 10D) may be from the bottom, and the pair of accouplements 10C and 10D may be crossed in contact or not in contact with each other in the thickness direction of the thermal insulation material (in the drawings, they are not in contact with each other) and inserted into the articles alignedly to thereby more effectively couple the articles of the three-layered structure, like in FIGS. 8A and 8B. In this case, the distance e between the pair of accouplements 10C and 10D in the lengthwise direction may be suitably from 5 to 40 mm, preferably from 10 to 30 mm; the distance f in the width direction may be from 50 to 500 mm, preferably from 100 to 200 mm; however, these distances may be suitably selected depending on the area and the thickness of the thermal insulation material. The accouplements 10C and 10D may not be in parallel to each other as illustrated, but may be tilted from each other.

In the above, a recess 5 may be formed in the second molded article 2 and an accouplement 10 may be embedded therein, as shown in FIG. 3.

Though not shown, two layers of the first molded article 1 may be laminated to increase the thermal insulation capability, and the second molded article 2 may be attached thereto. If desired, the thermal insulation material may have a four-layered or more multilayered structure. Further, not limited to a tabular form, the thermal insulation material may be curved, or may be semicylindrical.

While the invention has been described in detail and with reference to specific embodiments thereof, it will be apparent to one skilled in the art that various changes and modifications can be made therein without departing from the spirit and scope thereof.

The present application is based on a Japanese patent application (No. 2009-202742) filed Sep. 2, 2009 and a Japanese patent application (No. 2010-187403) filed Aug. 24, 2010, the entire contents thereof being hereby incorporated by reference.

All the references cited herein are hereby incorporated as a whole.

Additionally including the second molded article as coupled therein, the thermal insulation material of the invention has enhanced handlability, processability and workability while securing the excellent thermal insulation capability due to the first molded article of inorganic nanoparticles such as fumed silica. The production method is extremely simple, in which the first molded article and the second molded article are laminated and a rod-like or wire-like accouplement such as a pin is inserted therein.

### DESCRIPTION OF REFERENCE NUMERALS

1 First molded article
2 Second molded article
3 Coating material
5 Recess
6 Filler
10 Accouplement

1. A thermal insulation material comprising a first molded article formed by compression-molding inorganic nanoparticles, a second molded article laminated on at least one side of the first molded article and having a bending strength of at least 0.4 MPa, and an accouplement coupling the first molded article and the second molded article.

2. The thermal insulation material according to claim 1, wherein the accouplement is a rod-like or wire-like one.

3. The thermal insulation material according to claim 1, wherein the accouplement contains carbon or glass.

4. The thermal insulation material according to claim 2, wherein the accouplement contains carbon or glass.

5. The thermal insulation material according to claim 1, wherein the accouplement is embedded vertically or obliquely relative to an interface between the first molded article and the second molded article.

6. The thermal insulation material according to claim 2, wherein the accouplement is embedded vertically or obliquely relative to an interface between the first molded article and the second molded article.

7. The thermal insulation material according to claim 3, wherein the accouplement is embedded vertically or obliquely relative to an interface between the first molded article and the second molded article.

8. The thermal insulation material according to claim 4, wherein the accouplement is embedded vertically or obliquely relative to an interface between the first molded article and the second molded article.

9. A method for producing a thermal insulation material, said method comprising:
laminating a second molded article having a bending strength of at least 0.4 MPa on at least one side of a first molded article formed by compression-molding inorganic nanoparticles; and
inserting a rod-like or wire-like accouplement to couple the first molded article and the second molded article.

10. The method for producing a thermal insulation material according to claim 9, wherein said accouplement is inserted vertically or obliquely relative to an interface between the first molded article and the second molded article.
